(19) United States
(12) Patent Application Publication
(10) Pub. No.: US 2018/0096382 A1
(43) Pub. Date: Apr. 5, 2018

(54) SYSTEM AND METHOD FOR EXPANDING A POOL OF USERS THAT ARE TARGETED FOR AN ADVERTISEMENT BASED ON ADVERTISEMENT EXPOSURE

(71) Applicant: Rovi Guides, Inc., San Carlos, CA (US)

(72) Inventors: Benjamin H. Maughan, Pleasanton, CA (US); Paul Stathacopoulos, San Carlos, CA (US); Sean Matthews, Los Altos, CA (US)

(21) Appl. No.: 15/285,297

(22) Filed: Oct. 4, 2016

(51) Int. Cl. G06Q 30/02; G06F 17/30

(52) U.S. Cl. CPC G06Q 30/0246; G06Q 30/0269; G06F 17/3053

(57) ABSTRACT

Systems and methods are described for a more accurate system for targeting specific users for advertising. An advertisement-suitability score associated with each of a plurality of users may be determined and users may be split into subsets. Those users whose advertisement-suitability score is within a threshold of a target may be identified and selected to receive an advertisement. From the rest of the users, those who have already seen an advertisement for the target-product may be identified, and a determination may be made of how many times a user is exposed to an advertisement before the user buys a product. Those users whose advertisement exposure is within a certain threshold of the number of times a user is exposed to an advertisement before the user buys a product may be identified and an updated advertisement-suitability may be calculated so that more users can be targeted to receive an advertisement.

### BACKGROUND

In the related art, targeting certain advertisements to specific users has enabled advertisers to achieve better results while advertising their products. Current systems enable advertisers to utilize information about users (e.g., age, gender, and shopping habits) to target certain users (e.g., men between ages 18-55) for a specific product. However, these systems may not be accurate in capturing all users that should be targeted for an advertisement because there may be users that are similar to those targeted, but who do not quite fit the criteria set by the advertiser. For example, an advertiser may want to target men who are between the ages of 25 and 30 for advertising a product (e.g., a men's watch). However, some men who are, for example, 24 or 31, may also be good targets for the advertisement, and the advertiser may miss an opportunity for a sale because of this criterion. On the other hand, if an advertiser expands the target profile (e.g., adds five years to the age requirement), too many users who will ultimately not buy the advertised product may be targeted for an advertisement.

### SUMMARY

Therefore, systems and methods are described herein for a more accurate system for targeting specific users for advertising by analyzing advertisement exposure of those users who do not quite fit the target profile, but have been exposed to an advertisement for a target product. If a combination of advertisement exposure and data in the user's profile reaches a certain threshold score, the user is targeted for an advertisement.

Specifically, the system may determine an advertisement-suitability score associated with each user of a plurality of users and split users into subsets in order to arrive at a target subset of users. The system may identify those users whose advertisement-suitability score is within a threshold of a target and select those users to receive an advertisement. The system may identify, from the rest of the users, those who have already consumed an advertisement for the target-product and may determine, from user information, how many times a user is to be exposed to an advertisement before the user buys an advertised product. Based on that information and on the number of times the user has been exposed to an advertisement for the target product, the system may identify those users whose advertisement exposure is within a certain threshold of the number of times a user is exposed to an advertisement before the user buys a product and calculate an updated advertisement-suitability score taking into account the advertisement exposure data. The system may select those users whose updated advertisement-suitability scores meet the original threshold to receive an advertisement for the target product.

In some aspects, a media guidance application executed by control circuitry of a user equipment and/or server may be configured for expanding a pool of users that are targeted for an advertisement based on advertisement exposure. In order to avoid complicating the description, these systems and methods will be described in terms of a media guidance application. However, it should be noted that systems and methods described here may be utilized outside of a media guidance application.

The media guidance application may be used to determine advertisement-suitability scores associated with each user in a plurality of users. Specifically, the media guidance application may determine, based on a respective profile associated with each user of a plurality of users, a respective advertisement-suitability score associated with each user of the plurality of users, where the respective advertisement-suitability score indicates a measure of how likely each user of the plurality of users is to purchase a target product. For example, the media guidance application may use information in the user's profile (e.g., the user's age, gender, shopping habits, media asset viewing habits, and other suitable information) to calculate an advertisement-suitability score for each user. An advertisement-suitability score may reflect a likelihood that a specific user will purchase the target product. It should be noted that an advertisement-suitability score for the same user may be different for different products because the same user may be more likely to buy one product than another.

The media guidance application may use the calculated advertisement-suitability score to identify those users who should be targeted for an advertisement based on the information in their respective profiles. Specifically, the media guidance application may identify a first subset of the plurality of users, where each user of the first subset is associated with an advertisement-suitability score within a threshold of a target advertisement-suitability score. For example, the media guidance application may calculate a target advertisement-suitability based on user profiles of users who already bought the target product. Specifically, if a target product is a watch, the media guidance application may determine an age and gender associated with users who have already bought the watch. If, for example, seventy five percent of people who bought that watch were men between the ages of twenty five and thirty, the media guidance application may calculate the target advertisement-suitability score based on those user attributes. The media guidance application may set the target advertisement-suitability score at one hundred percent match or assign another number to the target advertisement-suitability score.

When the media guidance application determines the target advertisement-suitability score, the media guidance application may compare that score with an advertisement-suitability score associated with each user. Those users whose advertisement-suitability scores are within a specific threshold (e.g., within 20 percent) of the target advertisement-suitability score may be included in the first subset. For example, if user A has an advertisement-suitability score of 85 percent, then the media guidance application may include user A in the first subset because user A is within twenty percent (within a threshold) of the target advertisement-suitability score. It should be noted that any scale may be used for determining advertisement-suitability scores and the target advertisement-suitability scores as long as those values can be compared.

The media guidance application may identify those users whose advertisement-suitability scores are not within the threshold described above, but have consumed an advertisement for the target product. Specifically, the media guidance application may identify a second subset of the plurality of users, where the second subset does not include users in the first subset, and where the second subset includes users that have consumed an advertisement for the target product. The media guidance application may determine whether a specific user consumed an advertisement for a target product by accessing the user's profile and determining whether an advertisement for the target product was used in any of the media assets that the user has consumed. Additionally or alternatively, the media guidance application may access the user's browsing history on the Internet and determine whether the user visited any websites that contain an advertisement for the target product.

It should be noted that the user's viewing history and Internet history are just two examples of where the media guidance application may access information on whether the user has consumed an advertisement for the target product. In some embodiments, a database may be created that tracks users' activity across different mediums (e.g., Internet, television, radio, etc.) and stores users' exposure to different advertisements. The media guidance application may access the database in order to determine whether a specific user was exposed to an advertisement for a specific product.

For those users who have been exposed to an advertisement, the media guidance application may determine how many times each of those users was exposed to an advertisement for a respective other product before the respective user bought that respective other product. Specifically, the media guidance application may determine, for each user in the second subset, a respective first value corresponding to a respective number of times that an advertisement associated with a respective product of a plurality of respective products purchased by each respective user was transmitted to each respective user before each respective user purchased the respective product.

For example, user A may have been included in the second subset, based on actions described above. The media guidance application may access a profile associated with user A and select a product that user A has purchased in the past. The media guidance application may make a selection based on various criteria. For example, the media guidance application may select a product that was purchased the most number of times, a product that is similar to the target product or other suitable criteria. In some embodiments, instead of selecting one product, the media guidance application may calculate, for products that the user purchased, an average or a weighted average of a number of advertisements consumed by user A before user A purchased those products. The media guidance application may calculate the weighted average for all products purchased by the user or for only some (e.g., products of the same category as the target product).

The media guidance application may compare the number of times a user is exposed to an advertisement before the user buys a product with a number of advertisements consumed by the user that are associated with a target product. Specifically, the media guidance application may compare, for each user in the second subset, the respective first value with a respective second value, where the respective second value corresponds to a respective number of times each respective user in the second subset consumed an advertisement for the target product. For example, user A may have bought product B after consuming an advertisement for product B seven times. In addition, user A may have consumed an advertisement for a target product five times. The media guidance application may compare the two values.

Based on the comparison, a difference between the two values may be identified and those users for whom the difference is small enough may be added to a third subset. Specifically, the media guidance application may determine, for each user in the second subset, a respective difference between the respective second value and the respective first value and identify a third subset of users, where the third subset includes users included in the second subset who are associated with a respective difference that is within a predetermined amount of the respective first value. To continue with the example above, if the two values for user A are seven and five respectively, the difference of two may be small enough that user A may be added to the third subset.

It should be noted that the optimal number of advertisement exposures (i.e., the number of times that an advertisement is consumed by a user before purchasing the target product) leveraged as the determining factor to increase or decrease the initial suitability score may be determined in a variety of ways. For example, direct causal relationship may be established in instances where it is known that a specific user or group of users were exposed to a specific number advertisements before a purchase of the product in that advertisement, and that the advertisements caused the purchase. In another example, an inferred relationship may be established where it is probable that a user or group of users were likely exposed to a specific number of advertisements before a purchase of the product. Specifically, it may be known that a user or group of users purchased a product and it may also be known that the user or the group of users were exposed a specific number of times to an advertisement. Thus, it is reasonable to assume these advertisements impacted the decision to purchase the target product. In another example, the exposure information may be received from an advertiser, publisher, or an agency. In some embodiments, currently available advertisement technology maybe used to determine optimal number of exposures for the target audience (i.e., a number of advertisements that the user consumes before buying a specific product).

In some embodiments, the predetermined amount may be provided by an advertiser or another party, or may be calculated by the system from the information provided. For example, the predetermined amount may be twenty percent as specified in the system. In some embodiments, the predetermined amount may be set to a number that is one less than the number of times a user is exposed to an advertisement before the user buys a product so that when the user consumes the next advertisement the user will be at the number of times a user is exposed to an advertisement before the user buys a product and is more likely to buy the target product.

The media guidance application may recalculate advertisement-suitability scores for each user based on the difference between respective first and second values and target those users whose updated scores are equal to or greater than the threshold to receive an advertisement for the target product. Specifically, the media guidance application may determine an updated advertisement-suitability score associated with each user in the third subset, based on the respective difference for each user and update the first subset by adding users with associated updated advertisement-suitability scores that are equal to or greater than the threshold. For example, the target advertisement-suitability score for the target product may be set at one hundred percent and the threshold set at eighty percent. If user A has an advertisement-suitability score of seventy nine percent and consumed an advertisement for the target product six times, with the number of times a user is exposed to an advertisement before the user buys a product being seven times, the media guidance application may update the user's advertisement-suitability score to go past eighty percent, thereby raising the advertisement-suitability score associated with user A to a value beyond the threshold. The media guidance application may add user A to the first subset of users based on the updated advertisement-suitability score. The media guidance application may transmit an advertisement for the target product to the first subset of users.

In some embodiments, the media guidance application may determine an advertisement-suitability score associated with a user by taking the following actions. The media guidance application may retrieve, from a profile associated with a first user of the plurality of users, a plurality of characteristics associated with the first user. For example, the media guidance application may retrieve a user's demographics (e.g., age, gender), viewing habits, and other suitable characteristics. The media guidance application may determine a respective advertisement-suitability score associated with the first user based on the plurality of characteristics and a weight associated with each characteristic of the plurality of characteristics. For example, each characteristic may have an associated weight. Age and gender may be weighted very highly while a user's viewing habits may not be weighted very highly in comparison to age and gender. The media guidance application may calculate a weighted average of the retrieved characteristics in order to arrive at the advertisement-suitability score for a particular user.

In some embodiments, the media guidance application may determine a number of times a user is exposed to an advertisement before the user buys a product value associated with each user by taking the following actions. The media guidance application may retrieve, for a first user in the second subset, data associated with advertisements corresponding to a purchased product that were transmitted to the first user prior to the first user purchasing the purchased product. For example, user A may have consumed seven advertisements for a watch before user A bought the watch. Those seven consumed advertisements may have associated data, for example, the medium through which the advertisement was transmitted, the length of the advertisement, the times the advertisement was transmitted, and other suitable data. The media guidance application may determine, based on the retrieved data, a medium through which each advertisement was delivered. For example, of the seven advertisements consumed by user A, one may have been consumed through the Internet, five through television, and one through radio.

The media guidance application may retrieve a weight associated with each medium and modify the first value based on the weight associated with each medium through which each advertisement was delivered. For example, television advertisements may have a greater associated weight than radio advertisement because television users are more likely to pay attention to the advertisement or because user A watches TV much more than he or she listens to radio. Thus, the media guidance application may modify the number of times a user is exposed to an advertisement before the user buys a product for user A for the target product. Because user A consumed most of the advertisement through a higher weighted medium, the media guidance application may increase the number of times a user is exposed to an advertisement before the user buys a product from seven to eight.

In some embodiments, the media guidance application may determine the weights for different mediums based on how much time a specific user consumes content from the respective medium. Specifically, the media guidance application may determine an amount of time the first user consumed content from each respective medium, and generate, for the first user, a weight for each respective medium based on the amount of time that the first user consumed content from each respective medium. For example, if user A consumes content from a television fifty percent of the time, from the Internet twenty five percent of the time and from the radio twenty five percent of the time, the media guidance application may set a weight for the television twice as high as for Internet and radio.

In some embodiments, the media guidance application may adjust the second value based on user interactions with specific advertisements for the target product. For example, the media guidance application may determine that the user performed a rewind operation on the advertisement to watch the advertisement again. The media guidance application may increase the second value based on this user action as this user action may indicate that the user is interested in the target product. In another example, if the user is consuming an advertisement through a web page and the user selects the advertisement (e.g., clicks the ad on the web page) to get more information, the media guidance application may increase the second value based on this interaction. In yet another example, if the user is consuming an advertisement through a web page, the media guidance application may determine that the user closed the advertisement window. Based on this interaction, the media guidance application may decrease the second value as the user may not be interested in the target product based on his action.

In some embodiments, the media guidance application may determine the number of times a user is exposed to an advertisement before the user buys a product based on a category associated with the target product and categories of the products that a user purchased after consuming a respective number advertisements for those products. Specifically, the media guidance application may select a first user in the second subset, identifying a category associated with the target product, and identify a plurality of products purchased by the first user. The media guidance application may determine whether a product of the plurality of products purchased by the first user matches the category associated with the target product. In response to determining that the product of the plurality of products purchased by the first user matches the category associated with the target product, the media guidance application may assign the first value to a number of times that an advertisement associated with the selected first of the plurality of products purchased by the first user was consumed by the first user prior to the user purchasing the selected one of the plurality of products.

For example, the target product may be a bag of a specific brand. A profile associated with user A may include information that user A bought a bag of another brand after consuming seven advertisements, a car after consuming fifteen advertisements for the car and a soft drink after consuming four advertisements for the soft drink. The media guidance application may determine that the purchased bag is of the same category as the target product and use the number of times a user is exposed to an advertisement before the user buys a product associated with the bag (i.e., seven) as the first value.

In some embodiments, the user's purchasing history may not contain a purchased product of the same category as the target product. In those embodiments, the media guidance application may calculate an average number of times that a user consumed an advertisement for all products before the user bought those products in order to arrive at the number of times a user is exposed to an advertisement before the user buys a product. Specifically the media guidance application may in response to determining that no product of the plurality of products purchased by the first user matches the category associated with the target product, calculate the first value based on an average number of times that advertisements associated with each of the plurality of products purchased by the first user were consumed by the first user. To continue with the example above, the media guidance application may average three, seven, and fifteen in order to arrive at the first value.

In some embodiments, the media guidance application may use, as the number of times a user is exposed to an advertisement before the user buys a product, a value that corresponds to the number of times the user consumed an advertisement for a product that the user purchased the most. Specifically, the media guidance application may select the product of the plurality of products purchased by the user that matches the category associated with the target product by selecting a product that was purchased by the user more times than any other product associated with the category. For example, if a user bought a can of coke fifty times and a watch five times, the media guidance application may select, as the first value, the number of times a user is exposed to an advertisement before the user buys a product associated with the can of coke.

In some embodiments, the media guidance application may calculate an updated advertisement-suitability for each user based on a percent difference between the number of times a user is exposed to an advertisement before the user buys a product and the number of times that the user consumed an advertisement associated with the target product. The media guidance application may retrieve, for a first user, the respective difference, calculate, based on the respective difference, a percent difference between the first value and the second value, and calculate the updated advertisement-suitability score based on the percent difference between the first value and the second value.

For example, if the number of times a user is exposed to an advertisement before the user buys a product is ten and the user consumed nine advertisements associated with the target product, the percent difference may be calculated as ten percent. The media guidance application may raise the advertisement-suitability score by ten percent. In another example, if the percent difference is twenty, the media guidance application may raise the advertisement-suitability score by five percent.

In some embodiments, if the number of advertisements associated with the target product consumed by the user is greater than the number of times a user is exposed to an advertisement before the user buys a product, the media guidance application may remove those users from contention as targets for an advertisement. Because the number of advertisements associated with the target product consumed by the user is beyond the number of times a user is exposed to an advertisement before the user buys a product, the user may never buy the product and may just get annoyed at more advertisements. Thus, such user may not be a good candidate for advertisement for the target product. Specifically, the media guidance application may identify those users in the third subset whose associated second value is greater than their associated first value, and in response to identifying those users in the third subset whose associated second value is greater than their associated first value, remove those users from the third subset.

In some embodiments, the media guidance application may stop targeting all users that may not be interested in the target product. The media guidance application may identify in the first subset of users those users with an associated second value that is greater than the first value (i.e., users who have consumed a number of advertisements for the target product that is greater than a number corresponding to a point where the user buys the target product). In those instances, the media guidance application may remove users that have been originally part of the first subset and not part of the third subset from the first subset.

In some embodiments, the media guidance application may, when transmitting the advertisement for the target product to the first subset of users and the fourth subset of users, determine a target medium through which a first user consumes content more than through any other medium, and select the advertisement corresponding to the target medium to transmit to the user. For example, if the user consumes content through a television more than through the Internet or radio, the media guidance application may select a television advertisement to transmit to the user rather than an Internet advertisement or radio advertisement.

In some embodiments, the media guidance application may not have access to purchase data for specific users or purchase data may not exist for a specific user. Thus, the media guidance application may not be able to determine a number times a user is to be exposed to an advertisement before the user buys an advertised product. The media guidance application may select a second user that is similar to the original user and use the second user's data on the number of times that user is to be exposed to an advertisement before that user buys the advertised product. In some embodiments, the media guidance application may select a group of users that are similar to the original user. The media guidance application may select the second user or the group of users by, for example, selecting a user or a group of users that have similar demographics to those of the original user. In some embodiments, the media guidance application may select a user or a group of users that have similar media asset consumption history. In yet some embodiments, the media guidance application may retrieve the original user's profile and compare that user's profile to a profile of the second user. The user's profile data may contain various attributes associated with each respective user. For example, the user profile may include each respective user's preferences (e.g., favorite movies, favorite genres, favorite actors, and other suitable preferences). The media guidance application may compare those preferences and if the preferences match, the media guidance application may select a number times a user is to be exposed to an advertisement before the user buys an advertised product for the second user to be used in calculations for the original user. In the embodiments where a group of users is selected, the media guidance application may compare a profile associated with each of a plurality of users to determine which users of the plurality are similar to the original user. The comparison may be performed in the same manner as described above with respect to a single similar user.

In some aspects, a media guidance application may be configured to modify an advertisement-suitability score associated with a user. The media guidance application may retrieve an advertisement-suitability score associated with the user, the advertisement-suitability score indicating a measure of how likely the user is to purchase a target product. For example, the media guidance application may retrieve a previously calculated advertisement-suitability score from a database. In response to determining that the advertisement-suitability score is below the threshold, the media guidance application may retrieve a first value indicating a number of times that an advertisement associated with a purchased product was consumed by the user prior to the user purchasing the purchased product. For example, the media guidance application may calculate the first value, store it in a database, and retrieve it at a later time. The media guidance application may retrieve a second value indicating a number of times that an advertisement associated with the target product has been consumed by the user and, in response to determining that the second value is within a predetermined amount of the first value, the media guidance application may increase the advertisement-suitability score associated with the user.

### BRIEF DESCRIPTION OF THE DRAWINGS

FIG. 1 shows an illustration of a data structure that may be used in expanding a pool of users that are targeted for an advertisement based on advertisement exposure, in accordance with some embodiments of the disclosure;

FIG. 2 shows an illustrative embodiment of a display screen that may be used to provide media guidance application listings and other media guidance information, in accordance with some embodiments of the disclosure;

FIG. 3 shows another illustrative embodiment of a display screen that may be used to provide media guidance application listings, in accordance with some embodiments of the disclosure;

FIG. 4 is a block diagram of an illustrative device, in accordance with some embodiments of the disclosure;

FIG. 5 is a block diagram of an illustrative media system, in accordance with some embodiments of the disclosure;

FIG. 6 depicts an illustrative process for expanding a pool of users that are targeted for an advertisement based on advertisement exposure, in accordance with some embodiments of this disclosure;

FIG. 7 depicts an illustrative process involved in determining a number of times a user is exposed to an advertisement before the user buys a product associated with a target product, in accordance with some embodiments of this disclosure;

FIG. 8 depicts a continuation of the illustrative process involved in determining a number of times a user is exposed to an advertisement before the user buys a product value associated with a target product, in accordance with some embodiments of this disclosure;

FIG. 9 depicts an illustrative process for adding certain users to a set of users targeted for an advertisement based on advertisement exposure, in accordance with some embodiments of this disclosure; and

FIG. 10 depicts a graph that illustrates how advertisement consumption may affect an advertisement-suitability score associated with a user, in accordance with some embodiments of this disclosure.

### DETAILED DESCRIPTION

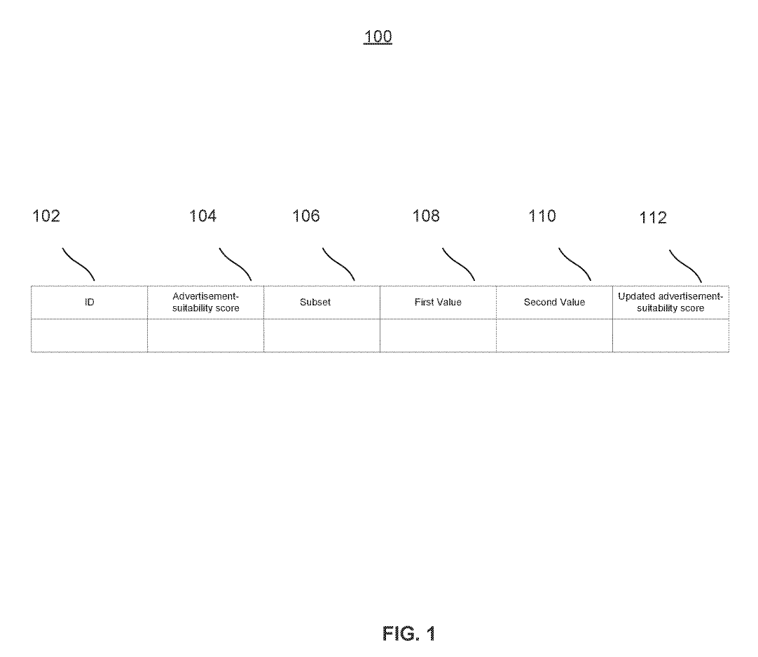

Systems and methods are described herein for a more accurate system for selecting specific users to receive advertisements associated with certain products. Advertisement exposure of those users who do not quite fit the target profile is analyzed, and if a combination of advertisement exposure and data in the user's profile reaches a certain threshold score, the user is selected to receive an advertisement for the target product. FIG. 1 depicts an illustration of a data structure that may be used in expanding a pool of users that are targeted for an advertisement based on advertisement exposure.

In some embodiments, data structure 100 may be used by a media guidance application in the process of determining which users should receive an advertisement associated with a target product and which users should not receive the advertisement. Data structure 100 may be stored in memory as a variable (e.g., an array of values). In some embodiments, data structure 100 may represent a row in a database with fields 102, 104, 106, 108, and 110 as column headings.

Field 102 of data structure 100 depicts a field to be used to store an identification (“ID”) associated with users that are being considered for selection to receive an advertisement associated with a target product. In some embodiments, field 102 may store, as a user ID, alpha-numeric characters that are unique for every user. In some embodiments, field 102 may store binary or hexadecimal data as a user ID. It should be noted that the user ID may be stored as any type of data that can uniquely identify a user. In some embodiments, the media guidance application may populate (e.g., via control circuitry 404) field 102 as it iterates through each user to determine a set of users to be selected for receiving an advertisement associated with the target product. For example, the media guidance application may receive a plurality of profiles associated with a plurality of users, respectively. The media guidance application may be configured to process each profile to determine whether to transmit an advertisement associated with the target product to a respective user associated with a respective profile. As the media guidance application processes each user, the media guidance application may generate a user ID for each respective user that is associated with a respective user profile or retrieve a user ID from the respective profile. The media guidance application may generate a user ID based on information in the user profile (e.g., via a hash algorithm of a combination of a user's name and address). In some embodiments, the media guidance application may generate an ID for each user using a random number generator and a suitable function for generating numbers.

In some embodiments, field 102 may be prepopulated and the media guidance application may use the ID in field 102 to access a respective profile associated with each user in order to determine whether to transmit an advertisement to that user. For example, user IDs might have already been generated for the users that are being considered to receive an advertisement for the target product. Each user ID may be associated with a respective profile. The media guidance application may iterate through ID fields 102 for each user and generate values for other fields based on the profile (e.g., fields 104, 106, 108, and 110).

The media guidance application may determine, based on a respective profile associated with each user of a plurality of users, a respective advertisement-suitability score associated with each user of the plurality of users, where the respective advertisement-suitability score indicates a measure of how likely each user of the plurality of users is to purchase a target product. When the determination is made, the media guidance application may store the advertisement-suitability score for each user in a respective field 104 of data structure 100. As referred to herein, an advertisement-suitability score refers to a value that indicates a measure of how likely a user is to purchase a product. It should be noted that one user may have different advertisement-suitability scores for different products. In some embodiments, the advertisement-suitability score for each user may be calculated based on a set of characteristics that define a perfect individual to purchase the target product. For example, the advertiser may have kept statistics on individuals that purchase the target product (e.g., a wristwatch). The advertiser may have determined that an average age of a person who buys the wristwatch is 35 years old. The advertiser may also have determined that seventy-five percent of people who buy this wristwatch are men. The advertiser may also have determined (e.g., from a survey that buyers take when buying the wristwatch) that sixty-five percent of the buyers like sports cars (e.g., because the wristwatch is associated with a specific sports car). The advertiser may enter this information into the system and come up with a target advertisement-suitability score.

In some embodiments, the advertisement-suitability score may be calculated in the following manner. As described above, the advertisement-suitability score may be based on three categories (i.e., age, gender, and preferences). These categories may be all given equal weight or may be weighted differently. For example, age may be weighted twice as high as age and preferences. Thus, if the target age is thirty-five and a certain user is thirty-seven years old, the age component of the advertisement-suitability score may calculated by subtracting a percentage difference of 35 and 37 from the age component of the score. Since gender is a binary calculation, a user may either get a full score of the gender component or none. It should be noted that because gender is a binary characteristic, in some embodiments, gender may not be weighted highly (e.g., five percent). Scores for other characteristics may be calculated in the same manner. For example, if one of the characteristics considered is a user's media asset consumption history (e.g., a product is known to be preferred by people who like action movies), that characteristic may be highly weighted. In some embodiments, the media guidance application may simply average the characteristics in the calculation without weighing them.

In order to populate field 106 for at least some users, the media guidance application may identify a first subset of the plurality of users, where each user of the first subset is associated with an advertisement-suitability score within a threshold of a target advertisement-suitability score. In some embodiments, the media guidance application may calculate the target advertisement-suitability score based on characteristics of those users that already purchased the target product, thereby creating an ideal target user for the product. As described above, these characteristics may include average age or an age interval, gender, and other suitable characteristics. In some embodiments, the media guidance application may set the target advertisement-suitability score to 100% and calculate an advertisement-suitability score for each user based on the difference between characteristics of the user and the ideal target user. For example, if the ideal target user is between the ages of 25 and 35 and an advertisement-suitability score is being determined for a user that is 22 years old, the media guidance application may subtract five percentage points from the ideal score to arrive at the advertisement-suitability score for that user. To continue with the example, if the ideal target user is someone who is female, but the advertisement-suitability score is being calculated for a male, the media guidance application may subtract 15 percentage points from the advertisement-suitability score for that user.

When both the target advertisement-suitability score and the advertisement-suitability score associated with a user have been determined, the media guidance application may determine whether the advertisement-suitability score is within a threshold of the target advertisement-suitability score. The media guidance application may receive a threshold value from an administrator of the system or calculate the threshold value based on the threshold values of past advertisement campaigns. Alternatively, the media guidance application may retrieve the threshold value from a remote server. The media guidance application may update field 106 to indicate the first subset for those users whose associated advertisement-suitability scores are within the threshold of the target advertisement-suitability score.

The media guidance application may populate field 106 for some other users by identifying a second subset of the plurality of users, where the second subset does not include users in the first subset, and where the second subset includes users that have consumed an advertisement for the target product. For example, the media guidance application may retrieve from a profile associated with each user not in the first subset whether that user consumed at least one advertisement associated with the target product. In some embodiments, the media guidance application may query a database that includes information on users and which products those users consumed advertisements for. The media guidance application may retrieve user IDs (e.g., IDs that may be matched to field 102) from the database to identify users that consumed at least one advertisement for the target product. The media guidance application may populate field 106 to indicate the second subset for those users that have consumed at least one advertisement associated with the target product.

The media guidance application may determine, for each user in the second subset, a respective first value corresponding to a respective number of times that an advertisement associated with a respective product of a plurality of respective products purchased by each respective user was transmitted to each respective user before each respective user purchased the respective product. The media guidance application may populate field 108 for each user in the second subset upon completing the determination. For example, the media guidance application may retrieve from the user's profile a value corresponding to a number of times that a specific user consumed an advertisement for a particular product that the user bought.

The media guidance application may compare, for each user in the second subset, the respective first value with a respective second value, where the respective second value corresponds to a respective number of times each respective user in the second subset consumed an advertisement for the target product. The media guidance application may retrieve the second value from the user's profile and populate respective field 110 with the value. In some embodiments, the media guidance application may access a database that stores information related to users' consumption of advertisements and retrieve the respective second values from the database.

The media guidance application may populate field 106 for more users by determining, for each user in the second subset, a respective difference between the respective second value and the respective first value and by identifying a third subset of users, where the third subset includes users included in the second subset who are associated with a respective difference that is within a predetermined amount of the respective first value.

For example, the media guidance application may use the first value and the second value to calculate the difference between the value. The media guidance application may receive the predetermined amount from an operator of the system or calculate the predetermined amount based on previous advertising campaigns. The media guidance application may populate field 106 with an indicator for the third subset for those users who are associated with a difference that is within the predetermined amount.

The media guidance application may determine an updated advertisement-suitability score associated with each user in the third subset, based on the respective difference for each user and update the first subset by adding users with associated updated advertisement-suitability scores that are equal to or greater than the threshold. For example, the media guidance application may use the difference between the first value and the second value to calculate a respective updated advertisement-suitability score for each user. For example, the media guidance application may be configured to increase the advertisement-suitability score by up to ten percent of the total score. Therefore, if the second value is within five percent of the first value, the media guidance application may increase the advertisement-suitability value by 9.5 percent, and if the second value is within twenty percent of the first value, the media guidance application may increase the advertisement-suitability score by 8.0 percent. The media guidance application may populate field 112 with the updated advertisement-suitability scores for each user, respectively.

The media guidance application may iterate through each updated advertisement-suitability score and identify users whose respective associated updated advertisement-suitability scores are equal to or above the threshold value discussed above. The media guidance application may update field 106 to indicate the first subset for those users whose associated advertisement-suitability scores are now above the threshold value. The media guidance application may identify all users whose associated field 106 indicates the first subset and transmit an advertisement for the target product to those users.

In some embodiments, the media guidance application may calculate an advertisement-suitability score for each user in the plurality of users starting with a first user. The media guidance application may retrieve, from a profile associated with a first user of the plurality of users, a plurality of characteristics associated with the first user. The media guidance application may search for a profile associated with the first user. In some embodiments, the media guidance application may search for the profile on the same device that the media guidance application is located (e.g., in storage 408). In some embodiments, the media guidance application may search for a user profile at a remote location (e.g., at media content source 516 and/or media guidance data source 518). In yet some embodiments, the media guidance application may perform a search locally first and then remotely afterwards. When the profile associated with first user is located, the media guidance application may retrieve from that profile a plurality of characteristics associated with the user. For example, the media guidance application may retrieve the user's demographics (e.g., age and gender) and/or the user's media-consuming habits. Other suitable characteristics may be retrieved by the media guidance application. The media guidance application may determine a respective advertisement-suitability score associated with the first user based on the plurality of characteristics and a weight associated with each characteristic of the plurality of characteristics. The media guidance application may retrieve, for each characteristic of the plurality of characteristics, from the profile of the first user a weight associated with that characteristic. In some embodiments, the weights may be the same across all users, while in other embodiments the weights may be unique for each user. The media guidance application may calculate the advertisement-suitability score based on the weights and store it in field 104 of data structure 100 (FIG. 1).

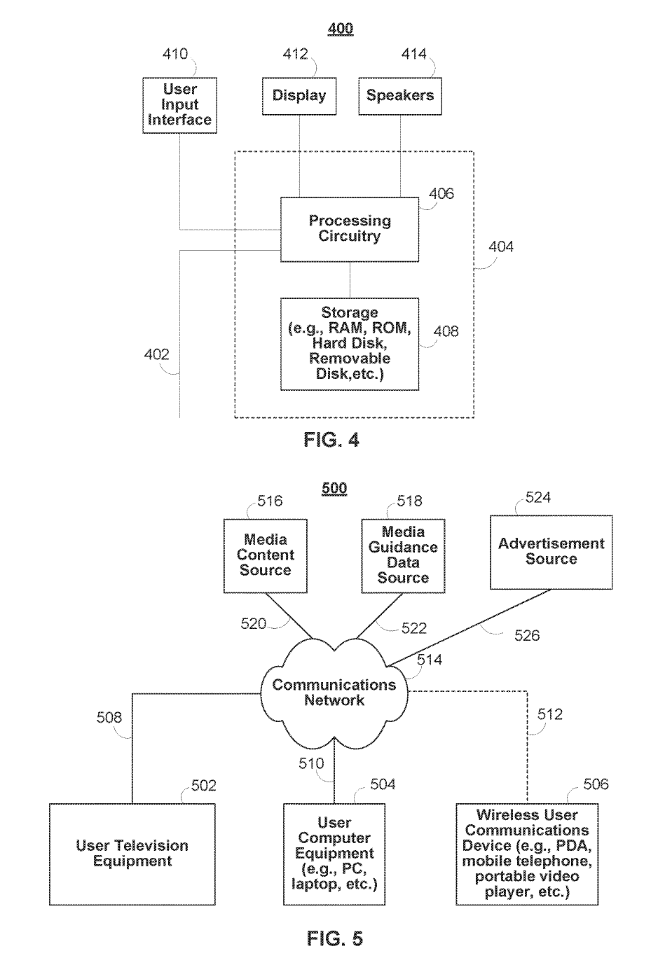

In some embodiments, the media guidance application may determine the first value for each user in the first subset by taking the following actions for each user starting with a first user. The media guidance application may retrieve, for a first user in the second subset, data associated with advertisements corresponding to a purchased product that were transmitted to the first user prior to the first user purchasing the purchased product. For example, as described above, the media guidance application may retrieve the data associated with an advertisement from a database. The database may be located locally in storage 408 (FIG. 4) or at a remote location (e.g., at media content source 516 and/or media guidance data source 518 (FIG. 5). The data may include, for each advertisement, an indication of a medium through which a respective advertisement was delivered and a weight associated with each medium. The media guidance application may determine, based on the retrieved data, a medium through which each advertisement was delivered, and retrieve a weight associated with each retrieved medium. The media guidance application may modify the first value based on the weight associated with each medium through which each advertisement was delivered. The media guidance application may store the first value in field 108 of data structure 100 (FIG. 1).

For example, the media guidance application may be configured to increase the first value by at most ten percent based on the respective weights of the medium through which advertisements for target products have been consumed. If the first value indicates that the user has consumed an advertisement for the target product three times, two times via television and one time via the Internet, and Television as a medium is associated with a weight of two while the Internet is associated with a weight of one, the media guidance application may increase the first value proportionally.

In some embodiments, the media guidance application may determine a weight associated with each medium with the following actions. The media guidance application may determine an amount of time the first user consumed content from each respective medium and generate, for the first user, a weight for each respective medium based on the amount of time that the first user consumed content from each respective medium. For example, if the user consumed content from a television for ten hours in a given week and from the Internet for five hours in the same week, the media guidance application may assign a value of one to the Internet and a value of two to television. It should be noted that the media guidance application may use any suitable values for the weights as long as the weights are proportional.

In some embodiments, the media guidance application may adjust the second value based on user interactions with specific advertisements for the target product. For example, the media guidance application may access a database that stores user information associated with different advertisements that the user has consumed. For every advertisement that the user has consumed the database may include an entry with fields that indicate the date and time that the user consumed the advertisement and any interactions that the user has had with the advertisement (e.g., rewind operation, close ad operation, select operation, or another suitable user interaction). The media guidance application may upon retrieval of the information iterate through each advertisement entry and determine whether the advertisement entry includes any associated user interactions. The media guidance application may compare each user interaction with a set of known user interactions (e.g., known user interaction stored in a different table in the database) to determine whether to increase, decrease, or maintain the second value based on the specific interaction.

In some embodiments, the media guidance application may determine, for each user in the second subset, the respective first value by taking the following actions. The media guidance application may iterate through each user in the second subset. The media guidance application may select a first user in the second subset. The media guidance application may identify a category associated with the target product and also identify a plurality of products purchased by the first user. For example, the media guidance application may access a database that includes data associated with a plurality of products. In some embodiments, the database may be located locally (e.g., in storage 408). In some embodiments, the database may be located remotely (e.g., at media content source 516 and/or at media guidance data source 518). In yet some embodiments, the database may be distributed between local storage and a remote location. In some embodiments, parts of the database may be cached to local storage to improve performance. The media guidance application may transmit a query to the database that includes an identification associated with the product (i.e., the target product) and a request for category information for the product. The media guidance application may receive, from the database, category information associated with the product. In some embodiments, category information may be provided by a third party (e.g., a manufacturer of the target product or an aggregator of product information).

The media guidance application may determine whether a product of the plurality of products purchased by the first user matches the category associated with the target product. For example, the media guidance application may iterate through each product that the user purchased and compare a category associated with that product with the category of the target product. In response to determining that the product of the plurality of products purchased by the first user matches the category associated with the target product (i.e., a match is found), the media guidance application may assign the first value to a number of times that an advertisement associated with the selected first of the plurality of products purchased by the first user was consumed by the first user prior to the user purchasing the selected one of the plurality of products.

For example, if the target is a watch (i.e., time-keeping category) and a user has purchased a clock in the past (also time-keeping category), the media guidance application when matching the category while iterating through all the purchased products may select as the first value the value corresponding to a number of times the user consumed an advertisement for the clock before the user bought the clock.

In some embodiments, the media guidance application may not find a match, and in response the media guidance application may average the values corresponding to a number of times that the user consumed an advertisement for all purchased products. Specifically, the media guidance application may, in response to determining that no product of the plurality of products purchased by the first user matches the category associated with the target product, calculate the first value based on an average number of times that advertisements associated with each of the plurality of products purchased by the first user were consumed by the first user.

In some embodiments, the media guidance application may select the product of the plurality of products purchased by the user that matches the category associated with the target product by selecting a product that was purchased by the user more times than any other product associated with the category. For example, if the advertised product is a pair of shoes (i.e., shoe category) and the user bought shoes ten times in the last year, the media guidance application may select a value corresponding to the shoes (e.g., a model or a brand) that the user bought the greatest number of times.

In some embodiments, the media guidance application may determine the updated advertisement-suitability score by taking the following actions. The media guidance application may retrieve, for a first user, the respective difference associated with the first user. The media guidance application may retrieve the respective difference from storage 408 or from a remote location (e.g., from media content source 516 or from media guidance data source 518). The media guidance application may calculate, based on the respective difference, a percent difference between the first value and the second value. For example, the media guidance application may use a percent difference mathematical formula in the calculation. The media guidance application may calculate the updated advertisement-suitability score based on the percent difference between the first value and the second value.

In some embodiments, the media guidance application may determine that the respective difference is negative (i.e., the second value may be greater than the first value). This would occur in the instances when a specific user consumed an advertisement for the target product more times than the number of times a user is exposed to an advertisement before the user buys a product. In some embodiments, the media guidance application may address that situation by taking the following actions. The media guidance application may identify those users in the third subset whose associated second value is greater than their associated first value, and, in response to identifying those users in the third subset whose associated second value is greater than their associated first value, remove those users from the third subset.

For example, the media guidance application may be configured to update the advertisement-suitability score by a maximum of twenty percent. If the percent difference between the first value and the second value is five percent, then the media guidance application may increase the updated advertisement-suitability score by ninety-five percent of the maximum of twenty percent (i.e., nineteen percent). If the difference is ten percent, then the media guidance application may increase the advertisement-suitability score by eighteen percent.

In some embodiments, the media guidance application may stop targeting all users that may not be interested in the target product. The media guidance application may iterate through each user in the first subset. For each user in the first subset, the media guidance application may determine whether an associated second value that is greater than the associated first value (i.e., users who have consumed a number of advertisements for the target product that is greater than a number corresponding to a point where the user buys the target product). The media guidance application may remove those users from the first subset.

In some embodiments, the media guidance application may take the following actions when transmitting the advertisement. The media guidance application may determine a target medium through which a first user consumes content more than through any other medium, and select the advertisement corresponding to the target medium to transmit to the user. For example, the media guidance application may retrieve from a database or a user's profile, as described above, data corresponding to user's media asset consumption habits. The media guidance application may calculate, for each medium, the amount of time that the user spent consuming media via that medium and transmit the advertisement via the medium that the user consumed content from the most amount of time.

In some embodiments, the media guidance application may not have access to purchase data for specific users or purchase data may not exist for a specific user. Thus, the media guidance application may not be able to determine a number times a user is to be exposed to an advertisement before the user buys an advertised product. The media guidance application may select a second user that is similar to the original user and use the second user's data on the number of times that user is to be exposed to an advertisement before that user buys the advertised product. In some embodiments, the media guidance application may select a group of users that is similar to the original users. The media guidance application may select the second user that has similar demographics. In the embodiments, where the media guidance application selects a group of users, the media guidance application may select those users with similar demographics to the original user (e.g., users within a specific age or of a specific gender). For example, the media guidance application may retrieve from storage 308 a profile associated with the user. In some embodiments, the media guidance application may retrieve the profile associated with the user from a server located at media content source 516 and/or media guidance data source 518.

In some embodiments, the media guidance application may request the profile from storage 308 first and then from a remove location (e.g., from media guidance content source 516 and/or media guidance data source 518). In some embodiments, the media guidance application may select a user that has similar media asset consumption history. This data may be retrieved from the same location as users' demographics (e.g., a user's profile). As discussed above, the media guidance application may retrieve the original user's profile and compare that user's profile to a profile of the second user. The user's profile data may contain various attributes associated with each respective user. For example, the user profile may include each respective user's preferences (e.g., favorite movies, favorite genres, favorite actors, and other suitable preferences). The media guidance application may compare those preferences and if the preferences match, the media guidance application may select a number times a user is to be exposed to an advertisement before the user buys an advertised product for the second user to be used in calculations for the original user. In some embodiments, the media guidance application may be configured to determine that the second user is similar to the original user when a certain percentage of data in the users' profiles match (e.g., twenty percent). In some embodiments, the media guidance application may determine a match if only one attribute within the users' profiles matches.

In some embodiments, the media guidance application may perform this process for a plurality of users in order to determine a group of users that are similar to the original user. The media guidance application may use an average or a weighted average of the number of times that the users in the group are to be exposed to advertisements for a product before the product is bought.

In some embodiments, advertisement source 524 may be configured to perform the actions described above. For example, advertisement source 524 may include one or more servers that maintain a database of advertisements that may be transmitted to a plurality of users. Advertisement source 524 may be configured to maintain user information including advertisement-suitability scores associated with user. Additionally or alternatively, a server associated with advertisement source 524 may be configured to store raw information that may be used to derive advertisement-suitability scores. In some embodiments, advertisement source 524 may transmit a request to another device for the raw information and calculate the advertisement-suitability scores. Advertisement source 524 may update advertisement-suitability scores for specific users (e.g., first subset, second subset, or third subset of users) and transmit an advertisement of the target product to appropriate users.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

As referred to herein, the term “in response to” refers to initiated as a result of. For example, a first action being performed in response to a second action may include interstitial steps between the first action and the second action.

As referred to herein, the term “directly in response to” refers to caused by. For example, a first action being performed directly in response to a second action may not include interstitial steps between the first action and the second action.

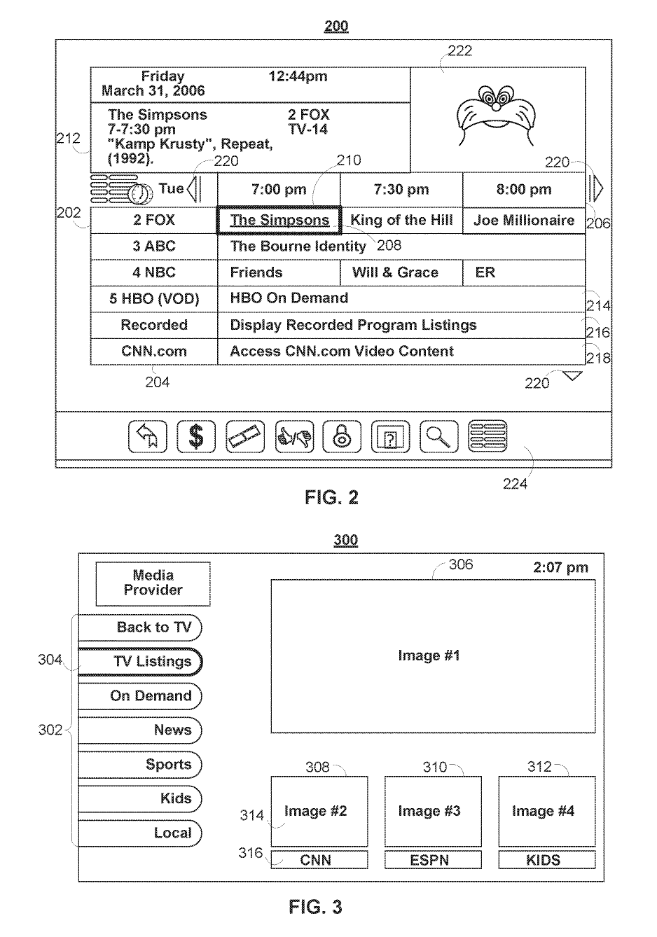

FIGS. 2-3 show illustrative display screens that may be used to provide media guidance data. The display screens shown in FIGS. 2-3 may be implemented on any suitable user equipment device or platform. While the displays of FIGS. 2-3 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 2 shows illustrative grid of a program listings display 200 arranged by time and channel that also enables access to different types of content in a single display. Display 200 may include grid 202 with: (1) a column of channel/content type identifiers 204, where each channel/content type identifier (which is a cell in the column) identifies a different channel or content type available; and (2) a row of time identifiers 206, where each time identifier (which is a cell in the row) identifies a time block of programming. Grid 202 also includes cells of program listings, such as program listing 208, where each listing provides the title of the program provided on the listing's associated channel and time. With a user input device, a user can select program listings by moving highlight region 210. Information relating to the program listing selected by highlight region 210 may be provided in program information region 212. Region 212 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 202 may provide media guidance data for non-linear programming including on-demand listing 214, recorded content listing 216, and Internet content listing 218. A display combining media guidance data for content from different types of content sources is sometimes referred to as a “mixed-media” display. Various permutations of the types of media guidance data that may be displayed that are different than display 200 may be based on user selection or guidance application definition (e.g., a display of only recorded and broadcast listings, only on-demand and broadcast listings, etc.). As illustrated, listings 214, 216, and 218 are shown as spanning the entire time block displayed in grid 202 to indicate that selection of these listings may provide access to a display dedicated to on-demand listings, recorded listings, or Internet listings, respectively. In some embodiments, listings for these content types may be included directly in grid 202. Additional media guidance data may be displayed in response to the user selecting one of the navigational icons 220. (Pressing an arrow key on a user input device may affect the display in a similar manner as selecting navigational icons 220.)

Display 200 may also include video region 222, and options region 226. Video region 222 may allow the user to view and/or preview programs that are currently available, will be available, or were available to the user. The content of video region 222 may correspond to, or be independent from, one of the listings displayed in grid 202. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 226 may allow the user to access different types of content, media guidance application displays, and/or media guidance application features. Options region 226 may be part of display 200 (and other display screens described herein), or may be invoked by a user by selecting an on-screen option or pressing a dedicated or assignable button on a user input device. The selectable options within options region 226 may concern features related to program listings in grid 202 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 5. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 3. Video mosaic display 300 includes selectable options 302 for content information organized based on content type, genre, and/or other organization criteria. In display 300, television listings option 304 is selected, thus providing listings 306, 308, 310, and 312 as broadcast program listings. In display 300 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 308 may include more than one portion, including media portion 314 and text portion 316. Media portion 314 and/or text portion 316 may be selectable to view content in full-screen or to view information related to the content displayed in media portion 314 (e.g., to view listings for the channel that the video is displayed on).

The listings in display 300 are of different sizes (i.e., listing 306 is larger than listings 308, 310, and 312), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. FIG. 4 shows a generalized embodiment of illustrative user equipment device 400. More specific implementations of user equipment devices are discussed below in connection with FIG. 5. User equipment device 400 may receive content and data via input/output (hereinafter “I/O”) path 402. I/O path 402 may provide content (e.g., broadcast programming, on-demand programming, Internet content, content available over a local area network (LAN) or wide area network (WAN), and/or other content) and data to control circuitry 404, which includes processing circuitry 406 and storage 408. Control circuitry 404 may be used to send and receive commands, requests, and other suitable data using I/O path 402. I/O path 402 may connect control circuitry 404 (and specifically processing circuitry 406) to one or more communications paths (described below). I/O functions may be provided by one or more of these communications paths, but are shown as a single path in FIG. 4 to avoid overcomplicating the drawing.

Control circuitry 404 may be based on any suitable processing circuitry such as processing circuitry 406. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for a media guidance application stored in memory (i.e., storage 408). Specifically, control circuitry 404 may be instructed by the media guidance application to perform the functions discussed above and below. For example, the media guidance application may provide instructions to control circuitry 404 to generate the media guidance displays. In some implementations, any action performed by control circuitry 404 may be based on instructions received from the media guidance application.

In client-server based embodiments, control circuitry 404 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 5). In addition, communications circuitry may include circuitry that enables peer-to-peer communication of user equipment devices, or communication of user equipment devices in locations remote from each other (described in more detail below).

Memory may be an electronic storage device provided as storage 408 that is part of control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 408 may be used to store various types of content described herein as well as media guidance data described above. Nonvolatile memory may also be used (e.g., to launch a boot-up routine and other instructions). Cloud-based storage, described in relation to FIG. 5, may be used to supplement storage 408 or instead of storage 408.

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and downconverting content into the preferred output format of the user equipment 400. Circuitry 404 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment 400, the tuning and encoding circuitry (including multiple tuners) may be associated with storage 408.

A user may send instructions to control circuitry 404 using user input interface 410. User input interface 410 may be any suitable user interface, such as a remote control, mouse, trackball, keypad, keyboard, touch screen, touchpad, stylus input, joystick, voice recognition interface, or other user input interfaces. Display 412 may be provided as a stand-alone device or integrated with other elements of user equipment device 400. For example, display 412 may be a touchscreen or touch-sensitive display. In such circumstances, user input interface 410 may be integrated with or combined with display 412. Display 412 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 412 may be HDTV-capable. In some embodiments, display 412 may be a 3D display, and the interactive media guidance application and any suitable content may be displayed in 3D. A video card or graphics card may generate the output to the display 412. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 404. The video card may be integrated with the control circuitry 404. Speakers 414 may be provided as integrated with other elements of user equipment device 400 or may be stand-alone units. The audio component of videos and other content displayed on display 412 may be played through speakers 414. In some embodiments, the audio may be distributed to a receiver (not shown), which processes and outputs the audio via speakers 414.

The guidance application may be implemented using any suitable architecture. For example, it may be a stand-alone application wholly-implemented on user equipment device 400. In such an approach, instructions of the application are stored locally (e.g., in storage 408), and data for use by the application is downloaded on a periodic basis (e.g., from an out-of-band feed, from an Internet resource, or using another suitable approach). Control circuitry 404 may retrieve instructions of the application from storage 408 and process the instructions to generate any of the displays discussed herein. Based on the processed instructions, control circuitry 404 may determine what action to perform when input is received from input interface 410. For example, movement of a cursor on a display up/down may be indicated by the processed instructions when input interface 410 indicates that an up/down button was selected.

In some embodiments, the media guidance application is a client-server based application. Data for use by a thick or thin client implemented on user equipment device 400 is retrieved on-demand by issuing requests to a server remote to the user equipment device 400. In one example of a client-server based guidance application, control circuitry 404 runs a web browser that interprets web pages provided by a remote server. For example, the remote server may store the instructions for the application in a storage device. The remote server may process the stored instructions using circuitry (e.g., control circuitry 404) and generate the displays discussed above and below. The client device may receive the displays generated by the remote server and may display the content of the displays locally on equipment device 400. This way, the processing of the instructions is performed remotely by the server while the resulting displays are provided locally on equipment device 400. Equipment device 400 may receive inputs from the user via input interface 410 and transmit those inputs to the remote server for processing and generating the corresponding displays. For example, equipment device 400 may transmit a communication to the remote server indicating that an up/down button was selected via input interface 410. The remote server may process instructions in accordance with that input and generate a display of the application corresponding to the input (e.g., a display that moves a cursor up/down). The generated display is then transmitted to equipment device 400 for presentation to the user.

In some embodiments, the media guidance application is downloaded and interpreted or otherwise run by an interpreter or virtual machine (run by control circuitry 404). In some embodiments, the guidance application may be encoded in the ETV Binary Interchange Format (EBIF), received by control circuitry 404 as part of a suitable feed, and interpreted by a user agent running on control circuitry 404. For example, the guidance application may be an EBIF application. In some embodiments, the guidance application may be defined by a series of JAVA-based files that are received and run by a local virtual machine or other suitable middleware executed by control circuitry 404. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 400 of FIG. 4 can be implemented in system 500 of FIG. 5 as user television equipment 502, user computer equipment 504, wireless user communications device 506, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 4 may not be classified solely as user television equipment 502, user computer equipment 504, or a wireless user communications device 506. For example, user television equipment 502 may, like some user computer equipment 504, be Internet-enabled allowing for access to Internet content, while user computer equipment 504 may, like some television equipment 502, include a tuner allowing for access to television programming. The media guidance application may have the same layout on various different types of user equipment or may be tailored to the display capabilities of the user equipment. For example, on user computer equipment 504, the guidance application may be provided as a web site accessed by a web browser. In another example, the guidance application may be scaled down for wireless user communications devices 506.

In system 500, there is typically more than one of each type of user equipment device but only one of each is shown in FIG. 5 to avoid overcomplicating the drawing. In addition, each user may utilize more than one type of user equipment device and also more than one of each type of user equipment device.

In some embodiments, a user equipment device (e.g., user television equipment 502, user computer equipment 504, wireless user communications device 506) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 514. Namely, user television equipment 502, user computer equipment 504, and wireless user communications device 506 are coupled to communications network 514 via communications paths 508, 510, and 512, respectively. Communications network 514 may be one or more networks including the Internet, a mobile phone network, mobile voice or data network (e.g., a 4G or LTE network), cable network, public switched telephone network, or other types of communications network or combinations of communications networks. Paths 508, 510, and 512 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path and paths 508 and 510 are drawn as solid lines to indicate they are wired paths (although these paths may be wireless paths, if desired). Communications with the user equipment devices may be provided by one or more of these communications paths, but are shown as a single path in FIG. 5 to avoid overcomplicating the drawing.

Although communications paths are not drawn between user equipment devices, these devices may communicate directly with each other via communication paths, such as those described above in connection with paths 508, 510, and 512, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 514.

System 500 includes content source 516 and media guidance data source 518 coupled to communications network 514 via communication paths 520 and 522, respectively. Paths 520 and 522 may include any of the communication paths described above in connection with paths 508, 510, and 512. Communications with the content source 516 and media guidance data source 518 may be exchanged over one or more communications paths, but are shown as a single path in FIG. 5 to avoid overcomplicating the drawing. In addition, there may be more than one of each of content source 516 and media guidance data source 518, but only one of each is shown in FIG. 5 to avoid overcomplicating the drawing. (The different types of each of these sources are discussed below.) If desired, content source 516 and media guidance data source 518 may be integrated as one source device. Although communications between sources 516 and 518 with user equipment devices 502, 504, and 506 are shown as through communications network 514, in some embodiments, sources 516 and 518 may communicate directly with user equipment devices 502, 504, and 506 via communication paths (not shown) such as those described above in connection with paths 508, 510, and 512.

System 500 may also include an advertisement source 524 coupled to communications network 514 via a communications path 526. Path 526 may include any of the communication paths described above in connection with paths 508, 510, and 512. Advertisement source 524 may include advertisement logic to determine which advertisements to transmit to specific users and under which circumstances. For example, a cable operator may have the right to insert advertisements during specific time slots on specific channels. Thus, advertisement source 524 may transmit advertisements to users during those time slots.

Content source 516 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 516 may be the originator of content (e.g., a television broadcaster, a Webcast provider, etc.) or may not be the originator of content (e.g., an on-demand content provider, an Internet provider of content of broadcast programs for downloading, etc.). Content source 516 may include cable sources, satellite providers, on-demand providers, Internet providers, over-the-top content providers, or other providers of content. Content source 516 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 518 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 518 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 518 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 518 may provide user equipment devices 502, 504, and 506 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 408, and executed by control circuitry 404 of a user equipment device 400. In some embodiments, media guidance applications may be client-server applications where only a client application resides on the user equipment device, and server application resides on a remote server. For example, media guidance applications may be implemented partially as a client application on control circuitry 404 of user equipment device 400 and partially on a remote server as a server application (e.g., media guidance data source 518) running on control circuitry of the remote server. When executed by control circuitry of the remote server (such as media guidance data source 518), the media guidance application may instruct the control circuitry to generate the guidance application displays and transmit the generated displays to the user equipment devices. The server application may instruct the control circuitry of the media guidance data source 518 to transmit data for storage on the user equipment. The client application may instruct control circuitry of the receiving user equipment to generate the guidance application displays.

Content and/or media guidance data delivered to user equipment devices 502, 504, and 506 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 500 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 5.

In one approach, user equipment devices may communicate with each other within a home network. User equipment devices can communicate with each other directly via short-range point-to-point communication schemes described above, via indirect paths through a hub or other similar device provided on a home network, or via communications network 514. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 516 to access content. Specifically, within a home, users of user television equipment 502 and user computer equipment 504 may access the media guidance application to navigate among and locate desirable content. Users may also access the media guidance application outside of the home using wireless user communications devices 506 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 514. These cloud resources may include one or more content sources 516 and one or more media guidance data sources 518. In addition or in the alternative, the remote computing sites may include other user equipment devices, such as user television equipment 502, user computer equipment 504, and wireless user communications device 506. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 504 or wireless user communications device 506 having content capture feature. Alternatively, the user can first transfer the content to a user equipment device, such as user computer equipment 504. The user equipment device storing the content uploads the content to the cloud using a data transmission service on communications network 514. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 4.

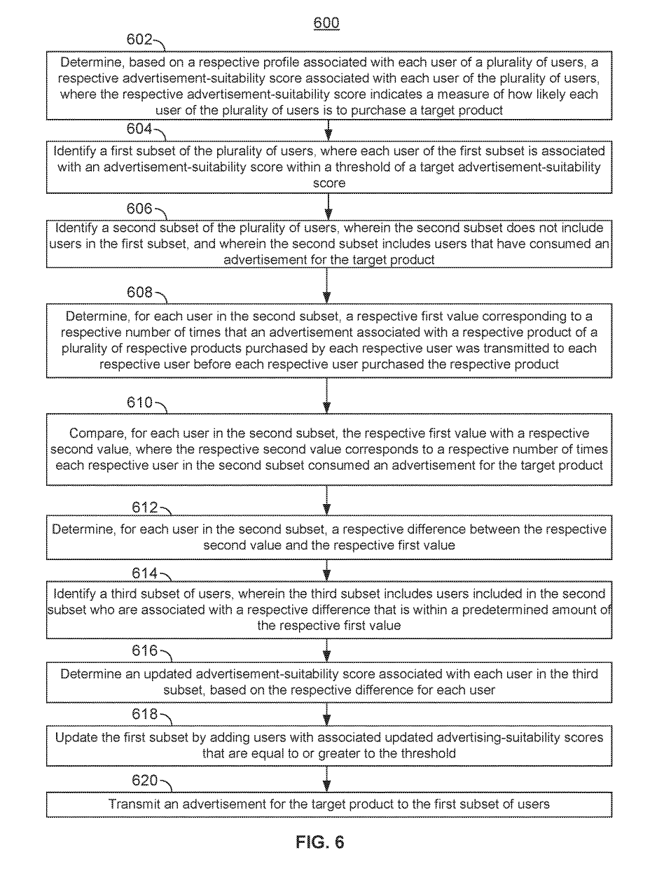

FIG. 6 depicts an illustrative process for expanding a pool of users that are targeted for an advertisement based on advertisement exposure. At 602, the media guidance application determines (e.g., via control circuitry 404), based on a respective profile associated with each user of a plurality of users, a respective advertisement-suitability score associated with each user of the plurality of users, where the respective advertisement-suitability score indicates a measure of how likely each user of the plurality of users is to purchase a target product. In some embodiments, the media guidance application may retrieve from a database that stores advertisement-suitability scores a respective advertisement-suitability score associated with each user of the plurality of users. The database may be located in storage 408 or at a remote server (e.g., a server located at media content source 516 and/or at media guidance data source 518). It should be noted that the database may be split between multiple servers located at different locations.

At 604, the media guidance application identifies (e.g., via control circuitry 404) a first subset of the plurality of users, where each user of the first subset is associated with an advertisement-suitability score within a threshold of a target advertisement-suitability score. One method of identifying the first subset of users has been discussed above in reference to FIG. 1. In some embodiments, the media guidance application may retrieve the target advertisement-suitability score and the threshold. The media guidance application may retrieve those values from storage 408 or from a remote server (e.g., a server located at media content source 516 and/or media guidance data source 518). In some embodiments, the media guidance application may calculate the target advertisement-suitability score for each user based on the respective profile of each user, as described in relation to FIG. 1. The media guidance application may compare the target advertisement-suitability score with a respective advertisement-suitability score for each user to determine whether a respective advertisement-suitability score is within the threshold of the target advertisement-suitability score. The media guidance application may add those users whose advertisement-suitability scores are within the threshold of the target advertisement-suitability score to the first subset.

At 606, the media guidance application identifies (e.g., via control circuitry 404) a second subset of the plurality of users, where the second subset does not include users in the first subset, and where the second subset includes users that have consumed an advertisement for the target product. One method of identifying the second subset has been described in relation to FIG. 1. The media guidance application may query a database that includes data associated with users, what advertisements those users consumed, and for which products. The database may be located locally in storage 408 or remotely at media guidance content source 516 and/or media guidance data source 518. It should be noted that the database may be split between servers that are located at media guidance content source 516 and media guidance data source 518. The media guidance application may transmit a query to the database that includes an identification associated with the target product to receive back IDs associated with users who have consumed at least one advertisement associated with the target product. The media guidance application may compare the received IDs with IDs associated with users being considered to receive an advertisement for the target product. The media guidance application may add users with matching IDs to the second subset. The media guidance application may use data structure 100 of FIG. 1 to update field 106 to indicate users of the second subset.

At 608, the media guidance application determines (e.g., via control circuitry 404), for each user in the second subset, a respective first value corresponding to a respective number of times that an advertisement associated with a respective product of a plurality of respective products purchased by each respective user was transmitted to each respective user before each respective user purchased the respective product. The media guidance application may determine the first value via actions described above with respect to FIG. 1. The media guidance application may, additionally or alternatively, access a database that contains data associated with shopping habits of different users. The database may be located locally in storage 408. In some embodiments, the database may be located remotely (e.g., at media content source 416, media guidance data source 518, or at another location). For example, the database may be hosted by a third party and the media guidance application may be able to access the database. The media guidance application may retrieve from the database information associated with all products that the user purchased. That information may include a value corresponding to a number of times that a respective user consumed an advertisement for that product. The media guidance application may select one of the products and use, as the first value, the value corresponding to the number of times the user consumed an advertisement for that product. The media guidance application may, for example, select a product that the user purchased the greatest number of times.

At 610, the media guidance application compares (e.g., via control circuitry 404), for each user in the second subset, the respective first value with a respective second value, where the respective second value corresponds to a respective number of times each respective user in the second subset consumed an advertisement for the target product. For example, the media guidance application may query a database that includes data associated with product advertisement and data associated with users that consumed those advertisements. The database may include for each user data for advertisements that the user has consumed, the products corresponding to those advertisements, information on the time of when those advertisements were consumed, and through what mediums. The database may include other suitable information. The media guidance application may, for each user in the second subset, transmit a query to the database that includes an identification of the target product, an identification of the user, and a request for a value corresponding to how many times the user consumed an advertisement for the target product. In some embodiments, the media guidance application may request from the database all information associated with each user and determine from that information how many times each user consumed an advertisement for the target product.

At 612, the media guidance application determines (e.g., via control circuitry 404), for each user in the second subset, a respective difference between the respective second value and the respective first value. The media guidance application may calculate a percent difference between the two values or may subtract one value from the other to determine the difference.

At 614, the media guidance application identifies (e.g., via control circuitry 404) a third subset of users, where the third subset includes users included in the second subset who are associated with a respective difference that is within a predetermined amount of the respective first value. For example, the media guidance application may retrieve, from a database or a data structure in storage (e.g., storage 408) the predetermined amount. The predetermined amount may be set by the advertiser. In some embodiments, the media guidance application may calculate the predetermined amount based on the predetermined amount of other advertising campaigns. For example, the media guidance application may retrieve a plurality of predetermined amounts associated with prior advertising campaigns and the corresponding respective first values and second values. The media guidance application may calculate a percent difference based on the respective predetermined amounts and the first and second values and determine an average percent difference. Based on the average, the media guidance application may calculate the predetermined amount for action 614.

At 616, the media guidance application determines (e.g., via control circuitry 404) an updated advertisement-suitability score associated with each user in the third subset, based on the respective difference for each user. The media guidance application may determine the updated advertisement-suitability value by performing actions described in relation to FIG. 1. In some embodiments, the media guidance application may determine the updated advertisement-suitability score by taking the following actions. The media guidance application may retrieve, for a first user, the respective difference associated with the first user. The media guidance application may retrieve the respective difference determined by action 612. The media guidance application may calculate, based on the respective difference, a percent difference between the first value and the second value. For example, the media guidance application may use a percent difference mathematical formula in the calculation. The media guidance application may calculate the updated advertisement-suitability score based on the percent difference between the first value and the second value.

In some instances, the media guidance application may determine that the respective difference may be negative (i.e., the second value may be greater than the first value). This would occur in the instances when a specific user consumed an advertisement for the target product more times than the sweet spot value. In some embodiments, the media guidance application may address that situation by taking the following actions. The media guidance application may identify those users in the third subset whose associated second value is greater than their associated first value, and in response to identifying those users in the third subset whose associated second value is greater than their associated first value, remove those users from the third subset.

For example, the media guidance application may be configured to update the advertisement-suitability score by a maximum of twenty percent. If the percent difference between the first value and the second value is five percent, then the media guidance application may increase the updated advertisement-suitability score by ninety-five percent of the maximum of twenty percent (i.e., nineteen percent). If the difference is ten percent, then the media guidance application may increase the advertisement-suitability score by eighteen percent.

At 618, the media guidance application updates (e.g., via control circuitry 404) the first subset by adding users with associated updated advertisement-suitability scores that are equal to or greater than the threshold. The media guidance application may compare, for each user in the third subset, the updated advertisement-suitability scores with the threshold. This comparison may be performed using actions described in relation to action 604. The difference is that updated advertisement-suitability scores are compared against the threshold for users in the third subset.

At 620, the media guidance application transmits (e.g., via control circuitry 404) an advertisement for the target product to the first subset of users. In some embodiments, the media guidance application may take the following actions when transmitting the advertisement. The media guidance application may determine a target medium through which a first user consumes content more than through any other medium, and select the advertisement corresponding to the target medium to transmit to the user. For example, the media guidance application may retrieve from a database or a user's profile, as described above, data corresponding to the user's media asset consumption habits. The media guidance application may calculate, for each medium, the amount of time that the user spent consuming media via that medium and transmit the advertisement via the medium that the user consumed content from the most amount of time.

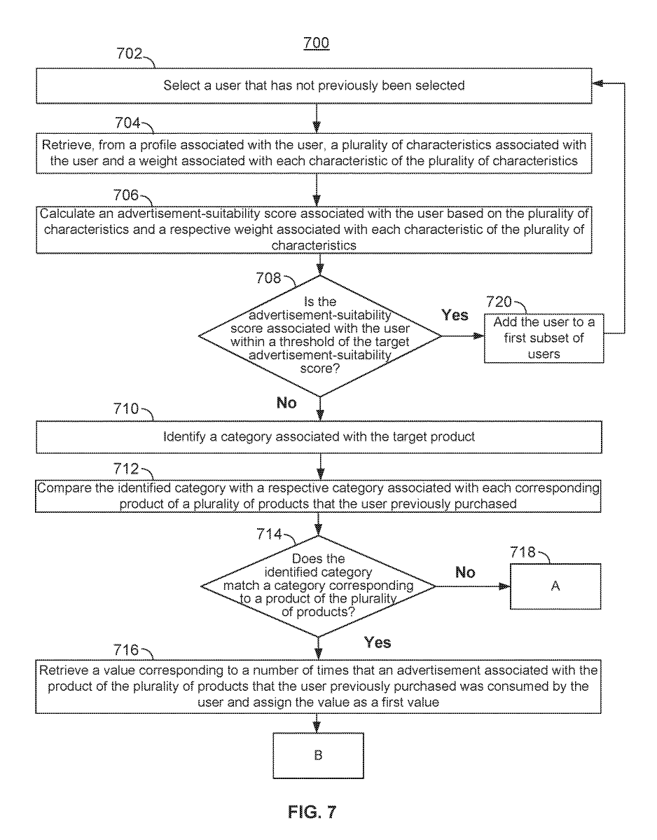

It is contemplated that the descriptions of FIG. 6 may be used with any other embodiment of this disclosure. In addition, the descriptions described in relation to the process of FIG. 6 may be done in alternative orders or in parallel to further the purposes of this disclosure. Furthermore, it should be noted that the process of FIG. 6 may be implemented on a combination of appropriately configured software and hardware, and that any of the devices or equipment discussed in relation to FIGS. 1-5 could be used to implement one or more portions of the process. Moreover, steps of process 600 may be used in conjunction with any step of process 700, 800, and 900. Steps of process 600 may be omitted or replaced with any step of process 700, 800 and/or 900. For example, the media guidance application may determine the first value as described in relation to FIG. 6 by replacing some or all of the actions of 608 with actions described in relation to process 700 of FIG. 7.

FIG. 7 depicts an illustrative process involved in determining a number of times a user is exposed to an advertisement before the user buys a product associated with a target product. At 702, the media guidance application selects (e.g., via control circuitry 404) a user that has not bee previously selected. For example, the media guidance application may have access to a plurality of users that are to be considered to receive an advertisement for the target product. The plurality of users may be accessible, for example, from a database that includes information about users. The database may include information such as a user ID, demographics (e.g., age, gender, height), user's preferences (e.g., preferences for media or brands), and other suitable information. The database may be located locally (e.g., in storage 408). In some embodiments, the database may be located on a remote server (e.g., a server at media content source 516 and/or a server at media guidance data source 518). It should be noted that the database can be located in both locations for redundancy purposes and more access options.

At 704, the media guidance application retrieves (e.g., via control circuitry 404), from a profile associated with the user, a plurality of characteristics associated with the user and a weight associated with each characteristic of the plurality of characteristics. For example, the profile associated with the user may be stored in the same database as the users and their demographics as discussed in relation to action 702. The media guidance application may query the database (e.g., through communications network 514) and retrieve the characteristics corresponding to the user who is being processed. Some methods of retrieving the user's profile are discussed in connection with FIG. 1 and FIG. 6.

At 706, the media guidance application calculates (e.g., via control circuitry 404) an advertisement-suitability score associated with the user based on the plurality of characteristics and a respective weight associated with each characteristic of the plurality of characteristics. The media guidance application may perform the calculation using actions similar to those as described in relation to FIG. 6.

At 708, the media guidance application determines (e.g., via control circuitry 404) whether the advertisement-suitability score associated with the user is within the threshold of the target advertisement-suitability score. The media guidance application may make the determination as described in relation to FIG. 6 or FIG. 1. In some embodiments, the media guidance application may retrieve the threshold from storage 308. In some embodiments, the media guidance application may transmit a request for the threshold to a database that may be located at a remote server (e.g., a server at media content source 516 or media guidance data source 518). The media guidance application may transmit the request via communications network 514. The media guidance application may query the database for the target advertisement-suitability score. In some embodiments, the media guidance application may calculate the target advertisement-suitability score. The media guidance application may make the calculation by taking actions described in relation to FIG. 1 or FIG. 6.

If the advertisement-suitability score is within the threshold of the target advertisement-suitability score, process 700 moves to action 720, where the media guidance application adds (e.g., via control circuitry 404) the user to a first subset of users and then process 700 moves to step 702, where another user is selected.

If the advertisement-suitability score is not within the threshold of the target advertisement-suitability score, process 700 moves to action 710, where the media guidance application identifies (e.g., via control circuitry 404) a category associated with the target product. FIG. 1 and FIG. 6 describe various ways that the media guidance application may identify a category associated with the target product.

At 712, the media guidance application compares (e.g., via control circuitry 404) the identified category with a respective category associated with each corresponding product of a plurality of products that the user previously purchased. The media guidance application may make the comparison by executing actions described in relation to FIG. 1 and FIG. 6.

At 714, the media guidance application determines (e.g., via control circuitry 404) whether the identified category matches a category corresponding to a product of the plurality of products. The media guidance application may make a determination in various ways (e.g., as described in relation to FIG. 1 and FIG. 6).

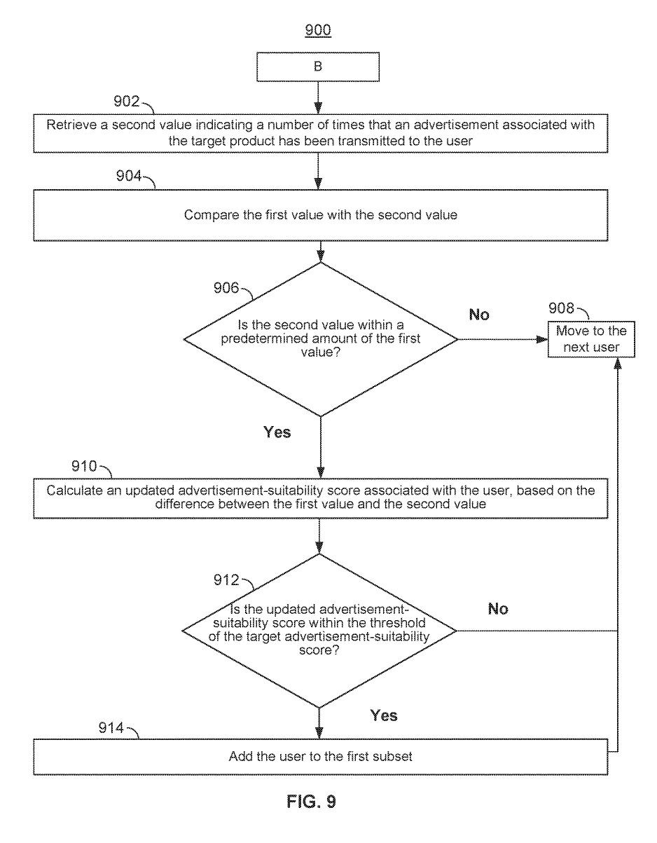

If the media guidance application determines that the identified category matches a category corresponding to a product of the plurality of products, process 700 moves to 716, where the media guidance application retrieves (e.g., via control circuitry 404) a value corresponding to a number of times that an advertisement associated with the product of the plurality of products that the user previously purchased was consumed by the user and assign the value as a first value. The media guidance application may retrieve the value from a database as described in relation to FIG. 1. FIG. 6 also describes a retrieval operation. The media guidance application now moves to process 900 of FIG. 9 that will be described below.

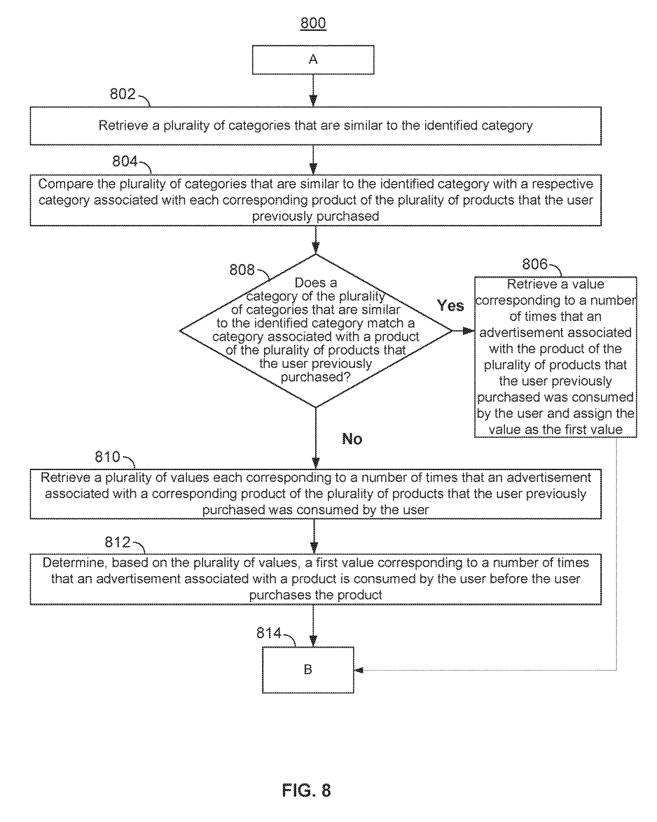

If the media guidance application determines that the identified category does not match a category corresponding to a product of the plurality of products, process 700 moves to action 718, where the media guidance application moves to process 800 of FIG. 8 that will be described below.

It is contemplated that the descriptions of FIG. 7 may be used with any other embodiment of this disclosure. In addition, the descriptions described in relation to the process of FIG. 7 may be done in alternative orders or in parallel to further the purposes of this disclosure. Furthermore, it should be noted that the process of FIG. 7 may be implemented on a combination of appropriately configured software and hardware, and that any of the devices or equipment discussed in relation to FIGS. 1-5 could be used to implement one or more portions of the process. Moreover, steps of process 700 may be used in conjunction with any step of process 600, 800, and 900. Steps of process 700 may be omitted or replaced with any step of process 600, 800 and/or 900.

FIG. 8 describes one possible continuation of process 700. Action 718 triggers process 800 of FIG. 8. At 802, the media guidance application retrieves (e.g., via control circuitry 404) a plurality of categories that are similar to the identified category. For example, every category may have an associated plurality of categories that are similar to the category (e.g., a chair may be associated with similar categories such as a couch, or bar stool, arm-chair, and sofa). The media guidance application may retrieve these categories from a database that stores product information. The database may be located locally in storage 408 or on a remote server (e.g., a server associated with media content source 516 or media guidance data source 518).

At 804, the media guidance application compares (e.g., via control circuitry 404) the plurality of categories that are similar to the identified category with a respective category associated with each corresponding product of the plurality of products that the user previously purchased. For example, the media guidance application may retrieve respective categories associated with each corresponding product of the plurality of products that the user previously purchased from local storage (e.g., storage 408) or from a remote server (e.g., a server located at media content source 516 or a server located at media guidance data source 518). The media guidance application may iterate through each similar category and through each category associated with products purchased by the user. During each iteration, a comparison of two categories may be performed by the media guidance application.

At 808, the media guidance application determines (e.g., via control circuitry 404) whether a category of the plurality of categories that are similar to the identified category match a category associated with a product of the plurality of products that the user previously purchased. The media guidance application may make the determination through the comparison step 806 described above. The comparison may be a textual comparison.

If a category of the plurality of categories that are similar to the identified category matches a category associated with a product of the plurality of products that the user previously purchased, process 800 moves to action 806, where the media guidance application retrieves (e.g., via control circuitry 404) a value corresponding to a number of times that an advertisement associated with the product of the plurality of products that the user previously purchased was consumed by the user and assigns the value as the first value. The media guidance application may retrieve the value from storage (e.g., storage 408) or from a remote server (e.g., a server located at media content source 516 or media guidance data source 518). Process 800 moves to action 814 and executes actions that are illustrated in process 900 of FIG. 9.

If no category of the plurality of categories that are similar to the identified category matches a category associated with a product of the plurality of products that the user previously purchased, process 800 moves to 810, where the media guidance application retrieves (e.g., via control circuitry 404) a plurality of values each corresponding to a number of times that an advertisement associated with a corresponding product of the plurality of products that the user previously purchased was consumed by the user. For example, the media guidance application may retrieve the value from one of the database described above in relation to FIG. 1, FIG. 6, or FIG. 7. In some embodiments, the media guidance application may retrieve the value from storage (e.g., storage 408 of FIG. 4).

At 812, the media guidance application determines (e.g., via control circuitry 404), based on the plurality of values, a first value corresponding to a number of times that an advertisement associated with a product is consumed by the user before the user purchases the product. For example, the media guidance application may calculate an average of all the values in order to determine the first value. In some embodiments, the media guidance application may calculate a weighted average of all the values. The weights may be determined by, for example, the number of times each product was purchased. If a watch was purchased twice and a computer once, the media guidance application may determine that the watch is assigned a weight of two while the computer is assigned a weight of one. At 814, the media guidance application executes process 900 of FIG. 9.

It is contemplated that the descriptions of FIG. 8 may be used with any other embodiment of this disclosure. In addition, the descriptions described in relation to the process of FIG. 8 may be done in alternative orders or in parallel to further the purposes of this disclosure. Furthermore, it should be noted that the process of FIG. 8 may be implemented on a combination of appropriately configured software and hardware, and that any of the devices or equipment discussed in relation to FIGS. 1-5 could be used to implement one or more portions of the process. Moreover, steps of process 800 may be used in conjunction with any step of process 600, 700, and 900. Steps of process 700 may be omitted or replaced with any step of processes 600, 700 and/or 900.

FIG. 9 illustrates a process that may be used to continue processes 700 and/or 800. However, it should be noted that process 900 may be executed independently of processes 700 or 800. At 902, the media guidance application retrieves (e.g., via control circuitry 404) a second value indicating a number of times that an advertisement associated with the target product has been transmitted to the user. The media guidance application may retrieve the value from local storage (e.g., storage 408) or from a remote server (e.g., a server located at media content source 516 or media guidance data source 518). The media guidance application may retrieve the value from a database as described in relation to any of FIG. 1, FIG. 6, FIG. 7, or FIG. 8.

At 904, the media guidance application compares (e.g., via control circuitry 404) the first value with the second value. For example, process 900 may receive the first value from process 800 (e.g., a value determined as part of actions 806 or 812). In some embodiments, process 900 may receive the first value from process 700 (e.g., a value determined as part of action 716). In yet some embodiments, process 900 may receive the first value from process 600 (e.g., action 608).

At 906, the media guidance application determines, based on the comparison, whether the second value is within a predetermined amount of the first value. The media guidance application may make the determination by using a method similar to the method described in relation to FIG. 6 (e.g., action 614 of FIG. 6). If the second value is not within the predetermined amount of the first value, process 900 moves to 908. At 908, the media guidance application moves to the next user. For example, the media guidance application may move to step 702 of FIG. 7 and select another user that has not previously been selected.

If the media guidance application determines that the second value is within the predetermined amount of the first value, process 900 moves to 910, where the media guidance application calculates (e.g., via control circuitry 404) an updated advertisement-suitability score associated with the user, based on the difference between the first value and the second value. The media guidance application may calculate the updated advertisement-suitability score using any of the methods described in relation to FIG. 1 and/or FIG. 6. The actions of those methods may be combined in the calculation.

At 912, the media guidance application determines (e.g., via control circuitry 404) whether the updated advertisement-suitability score is within the threshold of the target advertisement-suitability score. The media guidance application may perform the comparison using any method described in relation to FIG. 1 and/or FIG. 6. The actions of FIG. 1 and FIG. 6 may be combined in order to perform the determination. If the updated advertisement-suitability score is not within the threshold of the target advertisement-suitability score, the media guidance application moves to 908 and may select the next user. If the updated advertisement-suitability score is within the threshold of the target advertisement-suitability score, process 900 moves to 914. At 914, the media guidance application adds (e.g., via control circuitry 404) the user to the first subset. The media guidance application may perform action 914 by performing actions described in relation to FIG. 1 or FIG. 6. For example, the media guidance application may perform action 914 as described in relation to updating field 106 of data structure 100 of FIG. 1.

It is contemplated that the descriptions of FIG. 9 may be used with any other embodiment of this disclosure. In addition, the descriptions described in relation to the process of FIG. 9 may be done in alternative orders or in parallel to further the purposes of this disclosure. Furthermore, it should be noted that the process of FIG. 9 may be implemented on a combination of appropriately configured software and hardware, and that any of the devices or equipment discussed in relation to FIGS. 1-5 could be used to implement one or more portions of the process. Moreover, steps of process 900 may be used in conjunction with any step of processes 600, 700, and 800. Steps of process 700 may be omitted or replaced with any step of processes 600, 700 and/or 800.

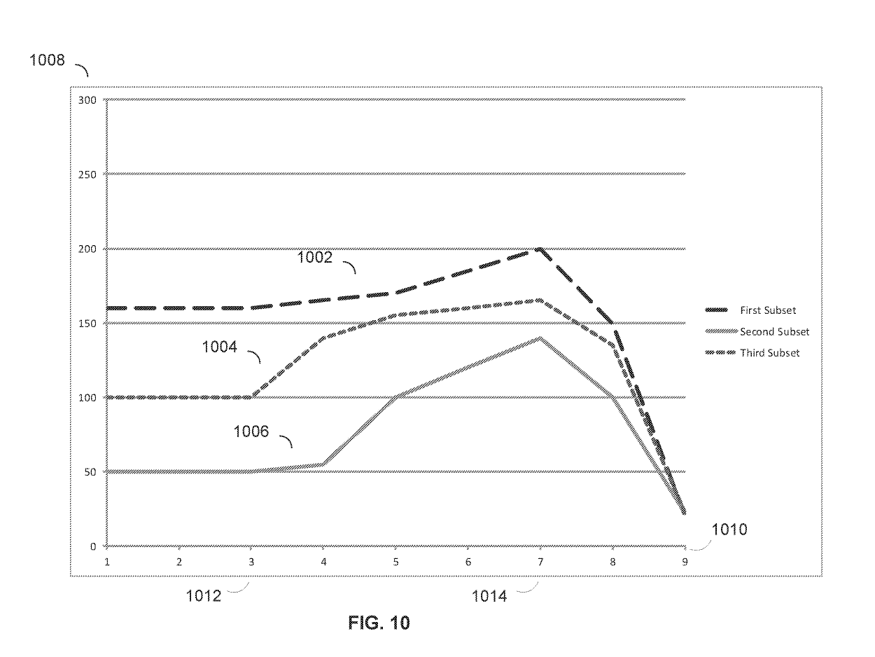

FIG. 10 depicts a graph that illustrates how advertisement consumption may affect an advertisement-suitability score associated with a user. Vertical axis 1008 represents an advertisement suitability score, while horizontal axis 1010 represents a number of times that a user consumed an advertisement for the target product. It should be noted that in this illustration value 150 has been chosen as a value at which a user is to be selected to receive an advertisement for the target product. However, this choice is for illustration purposes only. Curve 1002 may represent a curve associated with a user in the first subset, where this user starts out with an advertisement-suitability score within the range of scores for selection to receive an advertisement for the target product. As this user consumes more advertisements for the target product, his advertisement-suitability score is updated. After the user reaches three consumed advertisements (i.e., point 1012 on axis 1010), the user's advertisement-suitability score starts to increase as the user gets closer to a point where he is known, based on the methods described above, to buy the target product. When the user consumes seven advertisements for the target product (i.e., point 1014), the user's advertisement-suitability score is at the highest level as the user has reached the point where the user is known to buy the target product. After this point, the user's advertisement-suitability score starts to decrease as the user has consumed enough advertisements to buy the target product and may no longer buy the product at all. Thus, at this point, the media guidance application may not transmit an additional advertisement for the target product to the user.

Curve 1004 may represent a user in the third subset. Specifically, the user starts out with an advertisement-suitability score below the threshold number to receive an advertisement (i.e. score of 150). However, as the user gets to a specific point in the curve, the advertisement-suitability score associated with the user reaches above 150, where the user is selected to receive an advertisement for the target product. As the user consumes a number of advertisements beyond the point where the user buys the target product (i.e., point 1014), the user's advertisement-suitability score is decreased. Curve 1006 illustrates the change in an advertisement-suitability score for a user in the second subset that never reaches the threshold for selection to receive an advertisement. The curve behaves in a manner similar to curves 1002 and 1004.

In some embodiments, the media guidance application may be configured to transmit an advertisement for the target product to only a specific number of users. The media guidance application may select the users with the highest advertisement-suitability scores to receive the advertisement without regard to whether those users are in the first subset, second subset, or the third subset.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. (canceled)

2. A method for expanding a pool of users that are targeted for an advertisement based on advertisement exposure, the method comprising:
determining, based on a respective profile associated with each user of a plurality of users, a respective advertisement-suitability score associated with each user of the plurality of users, wherein the respective advertisement-suitability score indicates a measure of how likely each user of the plurality of users is to purchase a target product;
identifying a first subset of the plurality of users, wherein each user of the first subset is associated with an advertisement-suitability score within a threshold of a target advertisement-suitability score;
identifying a second subset of the plurality of users, wherein the second subset does not include users in the first subset, and wherein the second subset includes users that have consumed an advertisement for the target product;
determining, for each user in the second subset, a respective first value corresponding to a respective number of times that an advertisement associated with a respective product of a plurality of respective products purchased by each respective user was transmitted to each respective user before each respective user purchased the respective product;
comparing, for each user in the second subset, the respective first value with a respective second value, wherein the respective second value corresponds to a respective number of times each respective user in the second subset consumed an advertisement for the target product;
determining, for each user in the second subset, a respective difference between the respective second value and the respective first value;
identifying a third subset of users, wherein the third subset includes users included in the second subset who are associated with a respective difference that is within a predetermined amount of the respective first value;
determining an updated advertisement-suitability score associated with each user in the third subset, based on the respective difference for each user;
updating the first subset by adding users with associated updated advertisement-suitability scores that are equal to or greater than the threshold; and
transmitting an advertisement for the target product to the first subset of users.

3. The method of claim 2, wherein determining the respective advertisement-suitability score associated with each user of the plurality of users further comprises:
retrieving, from a profile associated with a first user of the plurality of users, a plurality of characteristics associated with the first user; and
determining a respective advertisement-suitability score associated with the first user based on the plurality of characteristics and a weight associated with each characteristic of the plurality of characteristics.

4. The method of claim 2, wherein determining, for each user in the second subset, the respective first value further comprises:
retrieving, for a first user in the second subset, data associated with advertisements corresponding to a purchased product that were transmitted to the first user prior to first the user purchasing the purchased product;
determining, based on the retrieved data, a medium through which each advertisement was delivered;
retrieving a weight associated with each medium; and
modifying the first value based on the weight associated with each medium through which each advertisement was delivered.

5. The method of claim 4, further comprising:
determining an amount of time the first user consumed content from each respective medium; and
generating, for the first user, a weight for each respective medium based on the amount of time that the first user consumed content from each respective medium.

6. The method of claim 2, wherein determining, for each user in the second subset, the respective first value comprises:
selecting a first user in the second subset;
identifying a category associated with the target product;
identifying a plurality of products purchased by the first user;
determining whether a product of the plurality of products purchased by the first user matches the category associated with the target product; and
in response to determining that the product of the plurality of products purchased by the first user matches the category associated with the target product, assigning the first value to a number of times that an advertisement associated with the selected first of the plurality of products purchased by the first user was consumed by the first user prior to the user purchasing the selected one of the plurality of products.

7. The method of claim 6, further comprising, in response to determining that no product of the plurality of products purchased by the first user matches the category associated with the target product, calculating the first value based on an average number of times that advertisements associated with each of the plurality of products purchased by the first user were consumed by the first user.

8. The method of claim 6, further comprising selecting the product of the plurality of products purchased by the user that matches the category associated with the target product by selecting a product that was purchased by the user more times than any other product associated with the category.

9. The method of claim 2, wherein determining the updated advertisement-suitability score associated with each user in the third subset comprises:
retrieving, for a first user, the respective difference associated with the first user;
calculating, based on the respective difference, a percent difference between the first value and the second value; and
calculating the updated advertisement-suitability score based on the percent difference between the first value and the second value.

10. The method of claim 2 further comprising:
identifying those users in the third subset whose associated second value is greater than their associated first value; and
in response to identifying those users in the third subset whose associated second value is greater than their associated first value, removing those users from the third subset.

11. The method of claim 2, wherein transmitting the advertisement for the target product to the first subset of users and the fourth subset of users comprises:
determining a target medium through which a first user consumes content more than through any other medium; and
selecting the advertisement corresponding to the target medium to transmit to the user.

12. A system for expanding a pool of users that are targeted for an advertisement based on advertisement exposure, the system comprising:
control circuitry configured to:
determine, based on a respective profile associated with each user of a plurality of users, a respective advertisement-suitability score associated with each user of the plurality of users, wherein the respective advertisement-suitability score indicates a measure of how likely each user of the plurality of users is to purchase a target product;
identify a first subset of the plurality of users, wherein each user of the first subset is associated with an advertisement-suitability score within a threshold of a target advertisement-suitability score;
identify a second subset of the plurality of users, wherein the second subset does not include users in the first subset, and wherein the second subset includes users that have consumed an advertisement for the target product;
determine, for each user in the second subset, a respective first value corresponding to a respective number of times that an advertisement associated with a respective product of a plurality of respective products purchased by each respective user was transmitted to each respective user before each respective user purchased the respective product;
compare, for each user in the second subset, the respective first value with a respective second value, wherein the respective second value corresponds to a respective number of times each respective user in the second subset consumed an advertisement for the target product;
determine, for each user in the second subset, a respective difference between the respective second value and the respective first value;
identify a third subset of users, wherein the third subset includes users included in the second subset who are associated with a respective difference that is within a predetermined amount of the respective first value;
determine an updated advertisement-suitability score associated with each user in the third subset, based on the respective difference for each user;
update the first subset by adding users with associated updated advertisement-suitability scores that are equal to or greater than the threshold; and
transmit an advertisement for the target product to the first subset of users.

13. The system of claim 12, wherein the control circuitry is further configured, when determining the respective advertisement-suitability score associated with each user of the plurality of users, to:
retrieve, from a profile associated with a first user of the plurality of users, a plurality of characteristics associated with the first user; and
determine a respective advertisement-suitability score associated with the first user based on the plurality of characteristics and a weight associated with each characteristic of the plurality of characteristics.

14. The system of claim 12, wherein the control circuitry is further configured, when determining, for each user in the second subset, the respective first value, to:
retrieve, for a first user in the second subset, data associated with advertisements corresponding to a purchased product that were transmitted to the first user prior to first the user purchasing the purchased product;
determine, based on the retrieved data, a medium through which each advertisement was delivered;
retrieve a weight associated with each medium; and
modify the first value based on the weight associated with each medium through which each advertisement was delivered.

15. The system of claim 14, wherein the control circuitry is further configured to:
determine an amount of time the first user consumed content from each respective medium; and
generate, for the first user, a weight for each respective medium based on the amount of time that the first user consumed content from each respective medium.

16. The system of claim 12, wherein the control circuitry is further configured, when determining, for each user in the second subset, the respective first value, to:
select a first user in the second subset;
identify a category associated with the target product;
identify a plurality of products purchased by the first user;
determine whether a product of the plurality of products purchased by the first user matches the category associated with the target product; and
in response to determining that the product of the plurality of products purchased by the first user matches the category associated with the target product, assign the first value to a number of times that an advertisement associated with the selected first of the plurality of products purchased by the first user was consumed by the first user prior to the user purchasing the selected one of the plurality of products.

17. The system of claim 16, wherein the control circuitry is further configured to, in response to determining that no product of the plurality of products purchased by the first user matches the category associated with the target product, calculate the first value based on an average number of times that advertisements associated with each of the plurality of products purchased by the first user were consumed by the first user.

18. The system of claim 16, wherein the control circuitry is further configured to select the product of the plurality of products purchased by the user that matches the category associated with the target product by selecting a product that was purchased by the user more times than any other product associated with the category.

19. The system of claim 12, wherein the control circuitry is further configured, when determining the updated advertisement-suitability score associated with each user in the third subset, to:
retrieve, for a first user, the respective difference associated with the first user;
calculate, based on the respective difference, a percent difference between the first value and the second value; and
calculate the updated advertisement-suitability score based on the percent difference between the first value and the second value.

20. The system of claim 12, wherein the control circuitry is further configured to:
identify those users in the third subset whose associated second value is greater than their associated first value; and
in response to identifying those users in the third subset whose associated second value is greater than their associated first value, remove those users from the third subset.

21. The system of claim 12, wherein the control circuitry is further configured, when transmitting the advertisement for the target product to the first subset of users and the fourth subset of users, to:
determine a target medium through which a first user consumes content more than through any other medium; and
select the advertisement corresponding to the target medium to transmit to the user.

22.-51. (canceled)
